(19) United States
(12) Patent Application Publication
(10) Pub. No.: US 2026/0151934 A1
(43) Pub. Date: Jun. 4, 2026

(54) METHOD FOR FABRICATING STRUCTURAL PANELS

(71) Applicant: OBSHCHESTVO S OGRANICHENNOI OTVETSTVENNOSTIU "AMATEC", Moscow (RU)

(72) Inventors: Igor Anatolevich STAVRULOV, Moscow (RU); Mohsen ZEHTABCHIAN, Toronto (CA)

(21) Appl. No.: 18/696,078

(22) PCT Filed: Dec. 28, 2023
(86) PCT No.: PCT/RU2023/000415

§ 371 Date: Mar. 27, 2024

(30) Foreign Application Priority Data
Dec. 26, 2023 (RU) 2023135286

(51) Int. Cl. B28B 23/22; B28B 1/52; B28B 7/22

(52) U.S. Cl. CPC B28B 23/22; B28B 1/52; B28B 7/22

(57) ABSTRACT

The invention relates to the area of construction, in particular to the fabrication of structural panels. The technical result of the invention is the reduction in the share of manual labor, simplification and acceleration of the process used to fabricate structural panels. A method for fabricating structural panels comprises the following stages: a) Forming the inner layer of the structural panel with required dimensions by placing functional units from the prefabricated set next to each other in the formwork; b) Filling the formwork with a bonding material to connect functional units to each other and to form the outer layers of a panel/building structure.

### FIELD OF THE INVENTION

The invention relates to the area of construction, in particular to the fabrication of structural panels.

### PRIOR ART

A major trend in today's construction industry is aimed at reducing the share of manual labor by fabricating large-sized construction elements in a factory environment and, subsequently, using them on a construction site (PreFab production). However, these practices mostly replicate, in some form or another, the construction methods previously used in construction sites. This is why they fail to significantly improve and accelerate the construction process or reduce its costs, as they either require the same amount of manual labor, but only at the production facilities, or they need very expensive and complex automated manufacturing which, in fact, imitates the processes that are typically performed manually by humans.

The overwhelming majority of mass-produced construction products such as plasterboard sheets, plywood, sheets of other construction materials, boards of various sizes, including those glued from several pieces, and the like require large amounts of manual labor for their applications. Today, the construction industry continues to find ways to simplify and cut the costs of mass-produced construction products, the use of which continues to be highly complex, requiring large amounts of manual labor and/or automated operations designed to mimic manual labor. This strategy used to be justified when there was plenty of low-cost labor. However, almost every country in the world has experienced a significant increase in the cost of manual labor and a shortage of workers in recent decades. This is one of the reasons behind the ongoing declining labor productivity of the construction industry in the last 30+ years.

Also, the all-purpose use of today's construction products results in a large amount of waste, which is often not recycled. In the current context of control over CO₂ emissions and demands for a cyclical economy, there are limits to the use of such legacy industrial approaches.

Therefore, new methods are needed to prefabricate panels which can be used to assemble buildings and which can be custom-made with a minimum amount of manual labor. Various three-layer panels have become very common today. Yet, they remain standardized which continues to require a great amount of manual labor, particularly for the installation of internal MEP systems.

Hereinafter, the term “customizability” means the capability of fabricating products to be used for a particular project without any special subsequent modification; at the same time, there could be some constraints on the design, which take into account the use of elements fabricated in accordance with that technical solution. Such design constraints are neither essential nor meaningfully constrictive to potential design solutions.

A method for fabricating structural panels known from prior art is disclosed in U.S. Pat. No. 9,649,662B2 published on May 22, 2014. The method includes placing concrete layers on a layer of insulating material, followed by leveling and hardening of the concrete layer.

This solution is typical and the disadvantage of the above method is that the inner layer is treated as a homogeneous, standard layer. To ensure the customizability of fabricated panels, there is a need to use a large amount of manual labor, in particular for accommodating any MEP system in the panel. There may be a special reinforcing groove in the standard insulation layer where it meets the solid layer, which cannot be considered a strong rib reinforcement to make the entire solid layer less thin.

In addition, a method for producing structural panels known from prior art is disclosed in US 2010/050555 A1, published on Mar. 4, 2010, and can be considered as a prototype of the present solution. The method for producing structural panels includes producing an insulating layer and then applying concrete to at least one surface of the insulating layer.

A disadvantage of the above method is also the use of a standardized item made of insulating material which is used to form the inner layer. In the process of fabricating the panels, such items are additionally processed to form a certain type of channels which, subsequently, after the bonding material is filled in and hardened within the channels, form a rib reinforcement. But in any case, at the start, this involves mass industrial scale production of a standard insulation product, which is then further processed before fabricating the panel.

### SUMMARY OF THE INVENTION

The claimed invention is aimed at reducing the share of manual labor in the fabrication of customized large-format structural items without the use of standard elements that are common today which require a large share of manual labor.

The technical result of the invention is the reduction in the share of manual labor, simplification and acceleration of the process used to fabricate structural panels.

This technical result is achieved by fabricating the structural items by using sets of prefabricated functional panel units (FPU) of different types which, depending on the location in the structural item and the requirements to the item, implement a specific function in such location of the item. Thus, a method for fabricating structural panels comprises the following steps:
a) Forming the inner layer of the structural panel with specified dimensions by placing functional elements/units from the prefabricated set next to each other in the formwork;
b) Filling the form with a bonding material to connect functional elements/units to each other and to form the outer layers of a panel/building structure.

The use of a particular FPU within the panel ensures the customizability of the fabricated panel. The sets of functional units are intended to provide a structural, utility, architectural, or design function within the panel. The set of functional units is represented by the following groups: functional units for the blind area of the wall, functional units for installing a window/door, functional units for connecting a panel to a column, functional units for longitudinal joining of adjacent panels, functional units for connecting panels at an angle of 90°/at an angle of less than 90°/at an angle of more than 90°, functional units for installation at the upper or lower edge of a wall panel, functional units for the blind area of a floor panel, functional units for organizing floor panel openings, functional units for stairwells, functional units with openings and channels for laying MEP systems and/or installing structural elements and/or placing fastening and/or slinging assemblies, architectural and decorative functional units.

The base width of functional units (FPUs) is specified as 300 mm (in metric system units; or 1 foot (304.8 mm), in imperial system units), and it is also acceptable to use FPUs with widths that are multiples of the base width of the elements, such as 600 mm or 900 mm or 2′ or 3′ or more, or that are multiples of a reduced width, such as ½, or ⅓, or ¼, or other value, of the base width of the elements.

The thickness of the functional units determines the thickness of the panel, where insulation parameters and structural parameters are important. The characteristics of the used insulation material determine the thickness required to obtain the desired properties of the panel. Therefore, FPU sets of specific thicknesses will be fabricated for specific climates or specific engineering requirements.

The length of the panel units is determined by the function they perform or the transportation conditions, and may be 1 meter or 1.2 meters when transported on pallets, or 6 meters or 10 meters or 12 meters when transported in trucks. FPUs can be customized to a specific order with the required length. If the FPUs are of insufficient length for their use, they are assembled from several elements by joining them lengthwise; if the length is longer than necessary, the excess portion is cut off and reused.

The use of prefabricated FPU sets enables the fabrication of a custom panel by assembling the required FPUs and then joining them together to form a complete structure. Using an assembly process to fabricate a custom panel allows to eliminate the need for special enhancements involving a large amount of manual labor.

To obtain the required strength and thermal or acoustic insulating properties of the panel, the functional units are made of insulating or structural insulating materials selected from the following groups:
Porous or foamed or extruded polystyrene/polypropylene/polyurethane/polyethylene and insulating polymers, including recycled polymers, such as those containing reinforcing fibers;
Plant-based or organic or chemical raw materials, including sawdust, straw, husks, chaff, fibers, plant waste, including recycled waste, such as paper, textile waste, including those compressed and/or glued, such as with the help of mineral and/or polymer-mineral binders;
Fiberglass or basalt fiber;
Materials based on mineral and polymer-mineral binders, such as cement, gypsum, magnesia, lime or ceramic binders, including their porous, foamed, aerated, volumetrically structured modifications, including those containing reinforcing fibers.

The functional units can also be fabricated as hollow vacuumized steel elements.

In this case, the inner layer of the structural panel comprises a set of functional units in which at least one functional unit differs from the others (has a different function).

The functional units may additionally contain a bonding material in their structure. For example, a functional unit intended for installation in a window panel will contain a bonding material layer on which the window will be installed and secured.

The following may be used as bonding material:
Concretes and composite materials containing a matrix of mineral or polymer-mineral binders or polymeric substances and fillers, including reinforcing fibers;
Composite polymer materials containing a matrix of UV-curable polymer with fillers, including reinforcing fiber;
Composite polymer material, in the form of an applied mass or sheet materials, comprising a matrix of heat shrinkable polymer, and fillers, such as those with reinforcing fibers;
Composite polymer material comprising a matrix of recycled polymer and fillers, in the form of applied mass or sheet materials;
Varnishes, mastics, glues, including composite materials comprising a matrix based on them and a filler, including those with reinforcing fibers.

The FPU surfaces facing the bonding material comprise longitudinal and/or transverse grooves that have a cross-sectional shape selected from the group of the following shapes: rectangular, trapezoidal, t-shaped, or rounded. Once the grooves are filled with the bonding material and hardened, the bonding material forms the rib reinforcement of the surface layers of the building structure.

Before filling in the bonding material, the grooves for laying the MEP systems can be formed on at least one surface of the created inner layer of the structural panel and/or in the lateral surface of the FPU, and this task can be easily performed in an automated manner without the use of manual labor.

Before filling in the bonding material, the pipes/channels/elements of MEP systems can be installed and secured in the formed grooves on at least one surface of the created inner layer of the structural panel.

Before filling in the bonding material, the reinforcing elements, meshes or objects made of materials selected from the group, which includes steel, glass or basalt reinforced polymers, other fiber-reinforced polymer composites, wood-or plant-based materials, including glued ones, are placed on the surface of the created inner layer.

FPUs made of different materials can be used when forming a structural panel.

The outer layers of the structural panel can be formed of different bonding materials.

The functional units may additionally comprise reinforcing elements or objects made of steel, wood-or plant-based material, glass or basalt reinforced polymers, other fiber-reinforced polymer composites that are partially protruding beyond the dimensions of the base material of the functional units and performing the function of joining or bonding the outer layers of bonding material to each other or the function of bonding the fabricated panels to each other.

When filling in the bonding material in panels intended for exterior walls, the longitudinal vertical hollow channel gaps, that act as a ventilating facade of the panel, can be formed between the outer layer of the bonding material facing the street and the functional units.

In addition, the reinforcing elements/objects made of strong material, steel, wood, glass or basalt reinforced polymers, other fiber-reinforced polymer composites, which join the two main formed outer layers to each other, or which are designed to bond the fabricated panels to each other, may be installed between the functional units.

Before applying a bonding material on the surface of the formed inner layer of the structural panel, the elements for rigging works and/or fasteners for joining the panels to each other and with other structural elements of the building are installed.

FPUs can additionally have channels filled with bonding material where the fasteners for hinged objects are subsequently installed.

A decorative coating is applied to the outer layers of the structural panel.

Various methods can be used to form the outer layers from the bonding material of the structural panel. In the first case, the required inner part of the FPU set is assembled in a horizontally arranged formwork, after which the bonding material forms the first outer layer on the surface of the formed inner part of the structural panel, then after the hardening of the first outer layer, the half-finished panel is turned over and the formwork is used to form the second outer layer on the second/other surface of the structural panel.

In the second method, the formwork is first filled with the bonding material, and then the inner layer is assembled on its surface from an FPU set, and next, the second outer layer is formed on the second surface of the formed inner layer of the structural panel.

In the third method, the panels are made in vertical formwork cassettes, then the assembled inner part is placed in the formwork, after which the bonding material is filled on two sides of the panel at once to form two outer layers.

Before filling in the bonding material, the junctions between the functional units and the joints of the functional units to the formwork are filled or covered with a layer of material that prevents the bonding material from entering the junctions and joints.

When filling in the bonding material, the bonding material may additionally find its way into forming the flank/outer perimeter of the structural panel

### BRIEF DESCRIPTION OF THE DRAWINGS

The invention will be better understood from a description, which is not restrictive and is provided with reference to the accompanying drawings that show the following:

FIG. 1. Cross-section of an FPU for a 300 mm wide blind area of the wall

FIG. 2. Cross-section of an FPU for a window/door installation; the dark color indicates the surface of the bonding material to which the window/door is installed.

FIG. 3. Simple FPU for a blind area of the wall with a short length: a) Top view of a simple FPU for a blind area of the wall; b) Cross-section of a simple FPU for a blind area of the wall, where trapezoidal grooves are made on the surfaces facing the bonding material.

FIG. 4. Simple FPU for a blind area of the wall (general view).

FIG. 5. FPU for joining blind wall panels at an angle of 90° (general view).

FIG. 6. Cross-section of an inner layer of a future structural panel for joining the panels at an angle of less than 90°, which is assembled from the following FPUs: corner unit for joining panels at an angle of 900; unit of a blind area of the wall; unit of a blind area of the wall with a width of ½ of the base width; unit for longitudinal joining of adjacent panels with a width of ½ of the base width of the FPU.

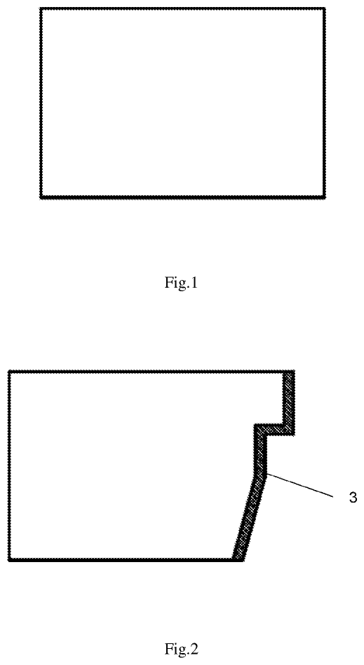

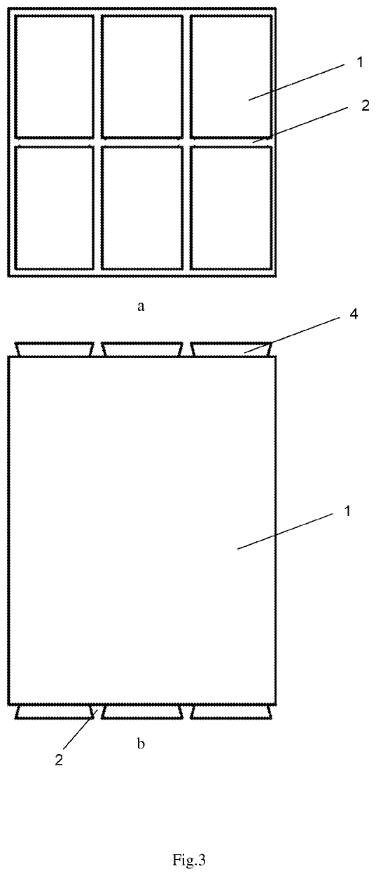

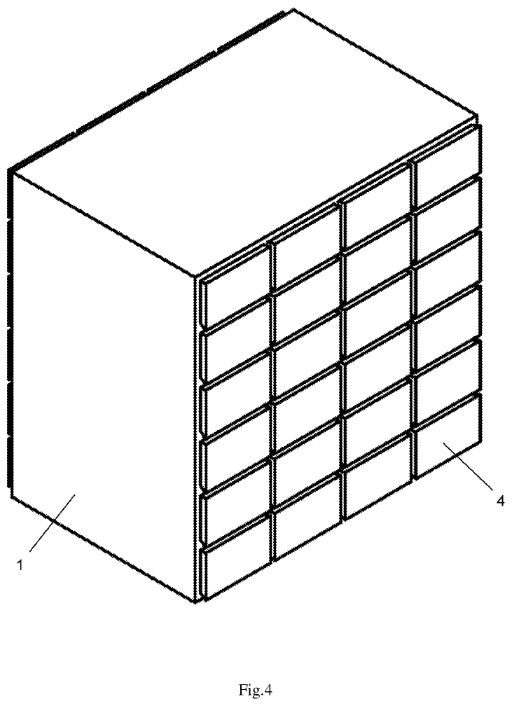

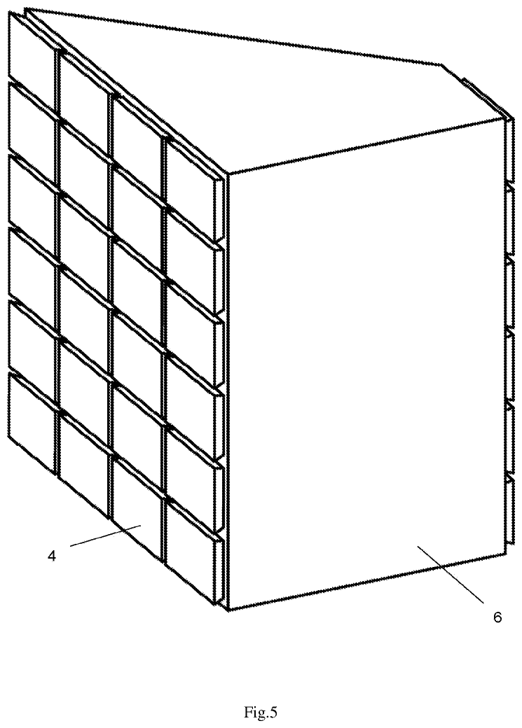

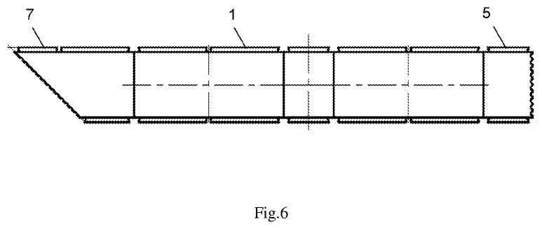

### EMBODIMENT OF THE INVENTION

The claimed method has the following embodiment. The first stage involves assembling the formwork with the overall dimensions (width, length and height) of the future structural panel. Next, the inner layer of the panel is formed by placing into the formwork the functional units from a set of different functional units (FPUs) that differ in terms of the function to be performed in the future panel. In the formwork, the functional units are placed next to each other to assemble successively several rows to the required dimensions of the future panel. The functional units are arranged so that there is a space for filling in the first layer of the future panel. When needed, a space is also left between the surface of the inner layer of the panel and the formwork walls to fill in the bonding material into the said space in order to form the flanks around the perimeter of the structural panel.

For example, a blind panel intended for a corner area of a building comprises the required number of functional units for a blind area of the wall, wherein one end of the panel has a functional units for joining the panels at an angle of 90°, and the other end of the panel has a functional unit for longitudinal joining of adjacent panels.

Another example includes a blind panel for a wall in the middle of a building, wherein such blind panel consists of the required number of functional units for a blind area of the wall, and the functional units for longitudinal joining of adjacent panels are installed on both ends of the panel. Therefore, the inner layer of the panel comprises a set of functional units in which at least one functional element differs from the others (has a different function).

Next, a layer of bonding material, e.g. concrete, is poured onto the inner layer of the panel formed in the formwork, and the first outer layer of the panel is formed after the hardening of such bonding material.

After that, the formwork is disassembled, and the half-finished panel is then turned over so that the finished outer layer is laid flat, and the formwork is assembled again to form the second outer layer of the panel. Then a layer of bonding material in the form of concrete is poured onto the second surface of the inner layer of the panel and, after the concrete has hardened, a second outer layer of the panel is formed on the second surface. Next, the formwork is disassembled and the finished item in the form of a panel is pulled out, and such finished item comprises an inner layer with outer layers formed on its outer surfaces.

The above steps result in a customizable and ready-to-use structural panel made of a set of functional units, with each unit performing a specific function within the panel. By using the above method to assemble the functional units, we can form the complete internal volume of the structural panel, including the channels/grooves/passageways required for MEP systems or with pre-installed MEP systems.

In addition, the finished item can be fabricated in another embodiment, wherein the inner layer is formed from a set of functional units (as disclosed above) in a formwork on a first layer of already pre-filled bonding material to form the first outer surface, after which a second layer of bonding material is filled in and, once the bonding material has hardened, the formwork is disassembled and the finished item is pulled out as a panel comprising an inner layer and two outer surfaces.

The heterogeneity of the utilized FPUs represents a substantial difference from existing technologies where panels are fabricated using homogeneous elements.

This approach enables a very rapid and very simple non-manual/automatic fabrication of any customized panel that has all the MEP systems built in or has the grooves required to accommodate such systems, and either has complete exterior and interior finishes, or those finishes are at their highest degree of completion.

The said approach allows to easily automate the fabrication of panels and substantially reduce the share of manual labor.

The invention has been disclosed above with reference to its particular embodiment. Other embodiments of the invention that do not change the essence of the invention as disclosed in this description may also be apparent to those skilled in the art. Accordingly, the invention should be considered limited in scope only by the claims below.

1. A method for fabricating structural panels comprising the following steps:
a) Forming the inner layer of the structural panel with required dimensions by placing functional units from the prefabricated set next to each other in the formwork;
b) Filling the formwork with a bonding material to connect functional units to each other and to form the outer layers of a panel/building structure.

2. A method according to claim 1 wherein the sets of functional units are intended to provide a structural, utility, architectural, or design function within the panel, and a set of functional units is represented by the following groups: functional units for blind area of the wall, functional units for installing a window/door, functional units for connecting a panel to a column, functional units for longitudinal joining of adjacent panels, functional units for connecting panels at an angle of 90°/at an angle of less than 90°/at an angle of more than 90°, functional units for installation at the upper or lower edge of a wall panel, functional units for the blind area of a floor panel, functional units for organizing floor panel openings, functional units for stairwells, functional units with openings and channels for laying MEP systems and/or installing structural elements/objects and/or placing fastening and/or slinging assemblies, architectural and decorative functional units.

3. A method according to claim 1 wherein the functional elements are fabricated from insulating materials selected from the following groups:
Porous or extruded polystyrene/polypropylene/polyurethane/polyethylene and insulating polymer, including recycled polymers, such as those containing reinforcing fibers;
Plant-based or organic or chemical raw materials, including sawdust, straw, husks, chaff, fibers, plant waste, including recycled waste, such as paper, textile waste, including those compressed and/or glued, such as with the help of mineral and/or polymer-mineral binders;
Fiberglass or basalt fiber;
Materials based on mineral and polymer-mineral binders, such as cement, gypsum, magnesia, lime or ceramic binders, including their porous, foamed, aerated, volumetrically structured modifications, including those containing reinforcing fibers;
Or the functional units can also be fabricated as hollow vacuumized steel elements.

4. A method according to claim 1 wherein the following can be used as bonding material:
Concretes and composite materials containing a matrix of mineral or polymer-mineral binders or polymeric substances and aggregates, including reinforcing fibers;
Composite polymer materials containing a matrix of UV-curable polymer with aggregates/fillers, including reinforcing fiber;
Composite polymer materials, either spread/molded or placed on top, comprising a matrix of thermally shrinkable polymers, and fillers, such as those with reinforcing fibers;
Composite polymer materials comprising a matrix of recycled polymers and fillers, either spread/molded or placed on top;
Varnishes, mastics, glues, including composite materials comprising a matrix based on them and a filler, including those with reinforcing fibers.

5. A method according to claim 1 wherein the surfaces of functional units facing the bonding material comprise longitudinal and/or transverse grooves that have a cross-sectional shape selected from the group of the following shapes: rectangular, trapezoidal, t-shaped, or rounded, and forming a rib reinforcement of the bonding material.

6. A method according to claim 1 wherein, before filling in the bonding material, the grooves for laying the MEP systems can be formed on at least one surface of the created inner layer of the structural panel and/or in the lateral surface of the functional units.

7. A method according to claim 1 wherein, before filling in the bonding material, the pipes/channels/elements of MEP systems can be installed and secured in the formed grooves on at least one surface of the created inner layer of the structural panel.

8. A method according to claim 1 wherein, before filling in the bonding material, the reinforcing elements, meshes or objects made of materials selected from the group, which includes steel, glass or basalt fiber-reinforced polymers, other fiber-reinforced polymer composites, wood-or plant-based materials, including glued ones, are placed on the surface of the created inner layer.

9. A method according to claim 1 wherein the functional units made of different materials can be used when forming a structural panel.

10. A method according to claim 1 wherein the outer layers of the structural panel can be formed of different bonding materials.

11. A method according to claim 1 wherein the functional units may additionally comprise reinforcing elements or objects made of steel, wood-or plant-based material, glass or basalt fiber-reinforced polymers and other fiber-reinforced polymer composites that are partially protruding beyond the dimensions of the base material of the functional units.

12. A method according to claim 1 wherein the reinforcing elements or objects made of steel, wood-or plant-based material, glass or basalt fiber-reinforced polymers, and other fiber-reinforced polymer composites may be additionally installed between the functional panels.

13. A method according to claim 1 wherein the longitudinal vertical hollow passageways, that act as a ventilated facade of the panel, can be formed when filling in the bonding material in the outer layer for panels intended for exterior walls.
